(19) United States
(12) Patent Application Publication
(10) Pub. No.: US 2004/0129389 A1
(43) Pub. Date: Jul. 8, 2004

(54) Method and device for forming a volatile substance by evaporation

(76) Inventor: Yves Lecoffre, Grenoble (FR)

Correspondence Address: YOUNG & THOMPSON, 745 SOUTH 23RD STREET 2ND FLOOR, ARLINGTON, VA, 22202

(21) Appl. No.: 10/250,576

(22) PCT Filed: Jan. 4, 2002
(86) PCT No.: PCT/FR02/00027

(30) Foreign Application Priority Data
Jan. 5, 2001 (FR) 01/00140

(51) Int. Cl. B01D 1/14; B01D 1/00; B01D 3/34

(52) U.S. Cl. 159/16.1; 159/44; 159/DIG. 27; 159/DIG. 28; 203/49

(57) ABSTRACT

The invention concerns a method and a device for forming by evaporation a volatile substance comprising at least a predetermined number of elementary constituents, wherein are provided means (205) for circulating in parallel fluxes of a gas controlled or regulated in flow rate through receptacles containing each at least an elementary constituent to be evaporated, and means (208) for the mixing gas streams loaded with evaporated contituents derived from said receptacles, so as to obtain an output gas stream containing predetermined or controlled concentrations of said evaporated constituents.

The evaporation of substances such as indoor perfumes generally takes place from porous media impregnated beforehand with the product to be diffused, the said porous media possibly being, for example, cellulosic supports, or pieces of pottery which are not completely glazed.

This method of evaporation, although widely used, gives mediocre results when the substances to be evaporated are constituted by several elementary constituents whose vapor pressures are different. Indeed, in such a situation, the most volatile constituents tend to evaporate more rapidly, leading to an enrichment of the perfume in the less volatile constituents, termed “heavy”.

The consequence of these phenomena is that the released odor changes with time, both in strength and in quality, which is not the purpose intended by the users, who in general wish to keep a constant odor during the whole period of evaporation.

To avoid these phenomena, perfume-metering techniques have been resorted to, such that the evaporation is regular and involves all of its constituents. Sprays can likewise be used, but their use requires an automatic or manual action which can in some cases constitute a constraint or an increased cost.

The object of the present invention is in particular to improve the methods and devices for manufacture and diffusion of volatile substances such as perfumes.

The ideal would indeed be to have the perfume diffuser permit the evaporation throughout its lifetime of a constant flow of perfume whose relative proportions of its various constituents would be equal to those the perfumer desires to obtain. The odor is indeed characterized by the concentrations in the air of the various substances constituting the perfume. For a given mixture of constituents, an ideal composition exists of these concentrations in the air. A good evaporator must thus be capable of permanently providing this ideal composition in the air.

Consequently, the desired aim would be that the initial proportions of the product to be evaporated in its different constituents would be identical to this ideal composition in the air. Apart from the constancy of the odor produced, the quantities of the various perfume constituents used are thus optimized, since these relative proportions of the various constituents of the product to be evaporated would thus remain constant.

To solve the abovementioned problems, the present invention firstly has as its object a method for constituting by evaporation a volatile substance comprising at least a predetermined number of elementary constituents.

According to the invention, this method consists in causing flows of a gas, controlled or regulated in flow rate, to flow in parallel through containers each containing at least one elementary constituent to be evaporated, and in mixing the flows of gas laden with the evaporated constituents leaving the said containers, so as to obtain an outlet flow of gas containing predetermined or controlled concentrations of the said evaporated constituents.

According to the invention, this method preferably consists in controlling or regulating the rate of flow of gas in each container by passing this gas through at least one calibrated or adjustable orifice.

According to the invention, this method preferably consists in passing the exit flow through at least one calibrated or adjustable orifice.

According to the invention, the elementary constituents to be evaporated are preferably impregnated into a permeable substance.

According to the invention, this method preferably consists in placing in at least certain of the said containers, elementary constituents of different volatilities.

According to the invention, this method preferably consists in independently regulating the flows of gas flowing in each of the containers.

The present invention likewise has as its object a device for constituting by evaporation a volatile substance comprising at least a predetermined number of elementary constituents.

According to the invention, this device comprises: means to cause flows of a gas, controlled or regulated in flow rate, to flow in parallel through containers each containing at least one elementary constituent to be evaporated, and means for mixing the flows of gas laden with the evaporated constituents leaving the said containers, so as to deliver at the outlet of the said mixing means a flow of gas containing predetermined or controlled concentrations of the said evaporated constituents.

According to the invention, the device preferably comprises means for calibrating and/or controlling the flow rate of gas passing through the said containers.

According to the invention, the device preferably comprises means for calibrating and/or controlling the flow rate leaving the said mixing means.

According to the invention, the said mixing means preferably comprise at least one chamber connected to the outlets of the said containers and having at least one outlet.

According to the invention, the said calibrating and/or controlling means preferably comprise at least one calibrated and/or adjustable orifice.

According to the invention, the said circulating means preferably comprise at least one fan.

According to the invention, the said containers preferably have calibrated or adjustable inlet and/or outlet orifices for gas flows passing through them.

According to the invention, at least certain of the containers may advantageously be equipped with heating means.

According to the invention, this device may advantageously comprise means for heating the gas flows passing through at least certain of the containers before the gas comes into contact with the constituents to be evaporated.

According to an alternative embodiment, the device according to the invention comprises a casing suitable for receiving a removable cartridge delimiting the containers having gas inlet orifices and gas outlet orifices, a mixing chamber into which the outlet orifices of the containers open and having at least one outlet orifice to the exterior, gas supply ducts connecting a gas inlet chamber to the inlet orifices of the containers and to the mixing chamber, and a gas supply fan in the inlet chamber.

According to the invention, the device preferably comprises a cover mounted on the said casing and having the said outlet orifice of the said mixing chamber to the exterior.

According to the invention, the said cover preferably comprises two portions having orifices and turning, one with respect to the other, so as to adjust the correspondence between these orifices.

According to the invention, the said elementary constituents are preferably impregnated into permeable substances constituted by ribbons rolled in spirals, the turns of which are spaced apart and disposed such that the flows of gas passing through the containers pass between these turns.

Other characteristics and advantages of the present invention will become more apparent on reading the following description of the principles and of several embodiments of the invention, given as examples which are in no way limiting. The description refers to the accompanying figures, in which:

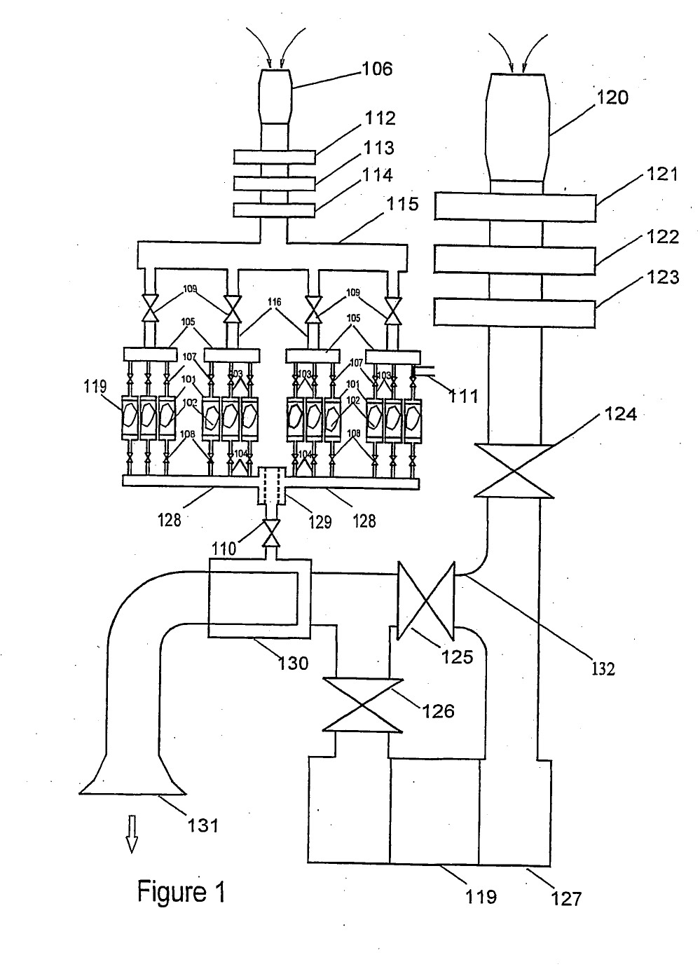

FIG. 1 shows, in a schematic sectional view, the principle of operation of a plurality of containers in which are placed porous elements impregnated with a single, chemically pure constituent, these containers being provided with a device for regulating the airflow passing through them, the said regulation being adjustable or not according to the user's needs. This device is particularly well suited for the elaboration of perfumes.

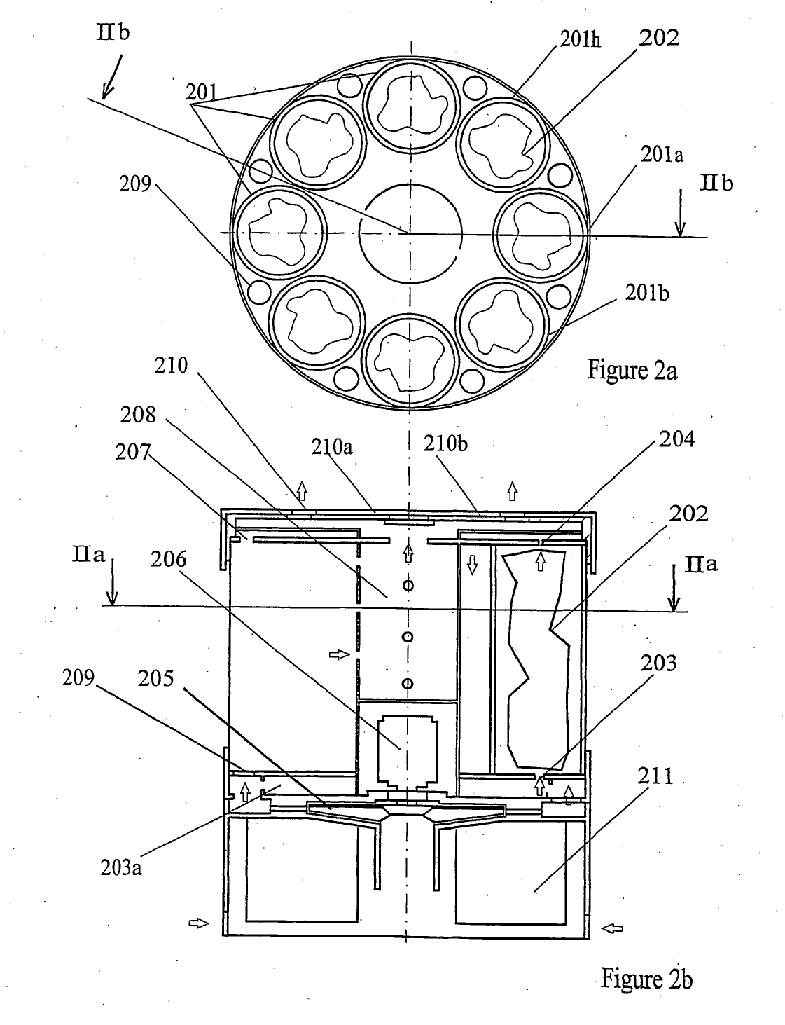

FIG. 2a shows a schematic horizontal section IIa-IIa, and FIG. 2b shows a vertical section along IIb-IIb, of another embodiment of the invention in which a limited number of containers are used whose porous elements are saturated with a mixture of elementary substances which are close in volatility, the passage of air into each of these containers according to a regulated flow rate permitting the evaporation of a quantity of perfume defined according to pre-established criteria. This device is particularly well suited to the diffusion of perfume throughout a house.

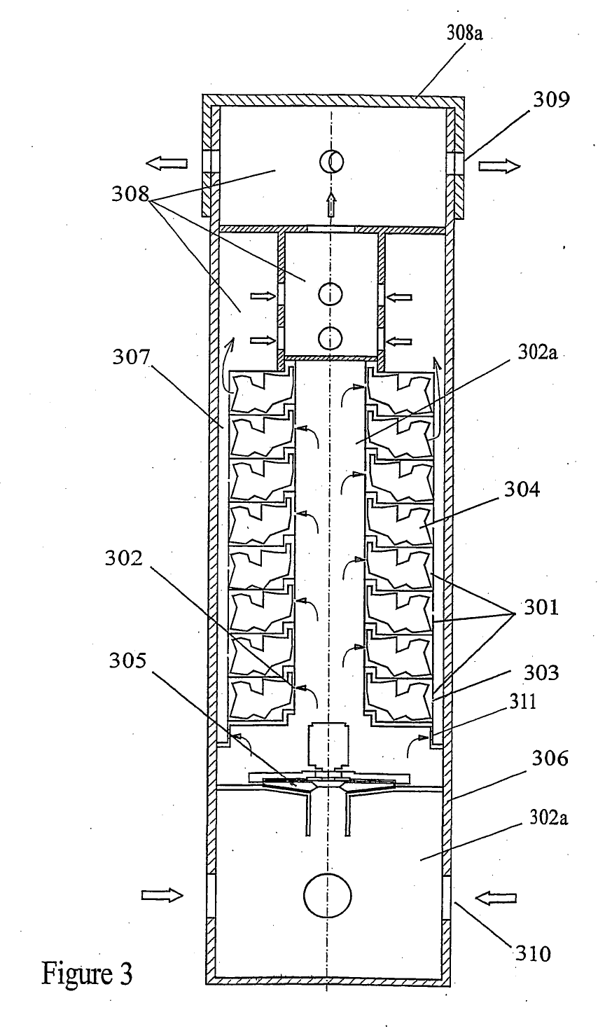

FIG. 3 shows, in vertical section, an example of a set of perfume diffusers according to the invention in which the flow rates of evaporated material are very large and are for example suited to perfuming very large spaces such as, for example, the halls of public transportation stations.

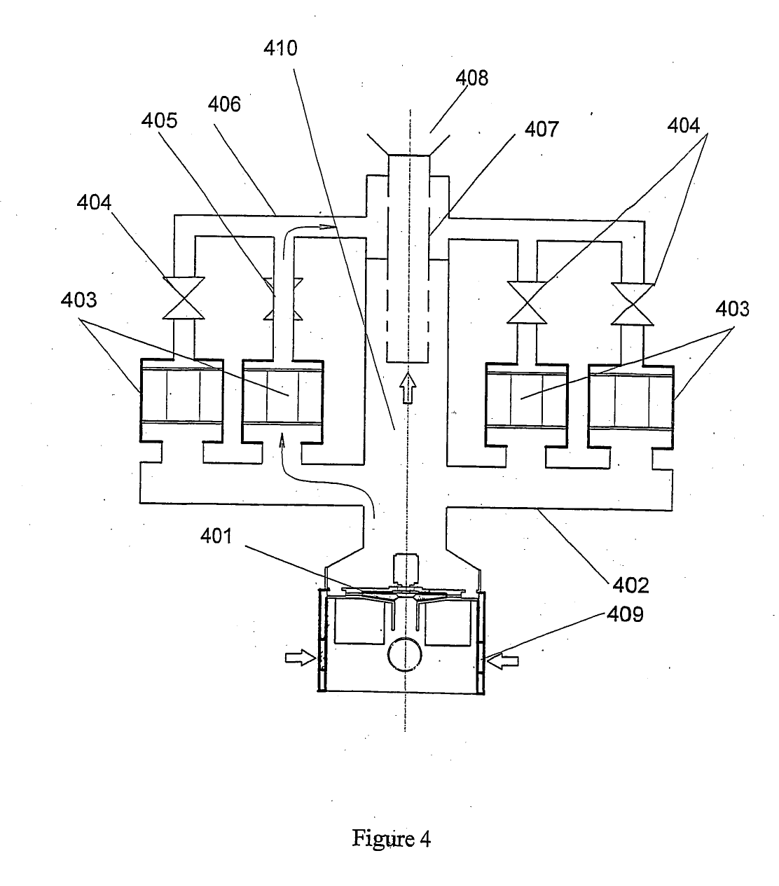

FIG. 4 shows, in a schematic sectional view, a display unit for perfumed products in which a collection of odors is placed which will be precisely metered according to the invention by simple use of one or other of the sets of containers permitting the diffusion of the desired perfume.

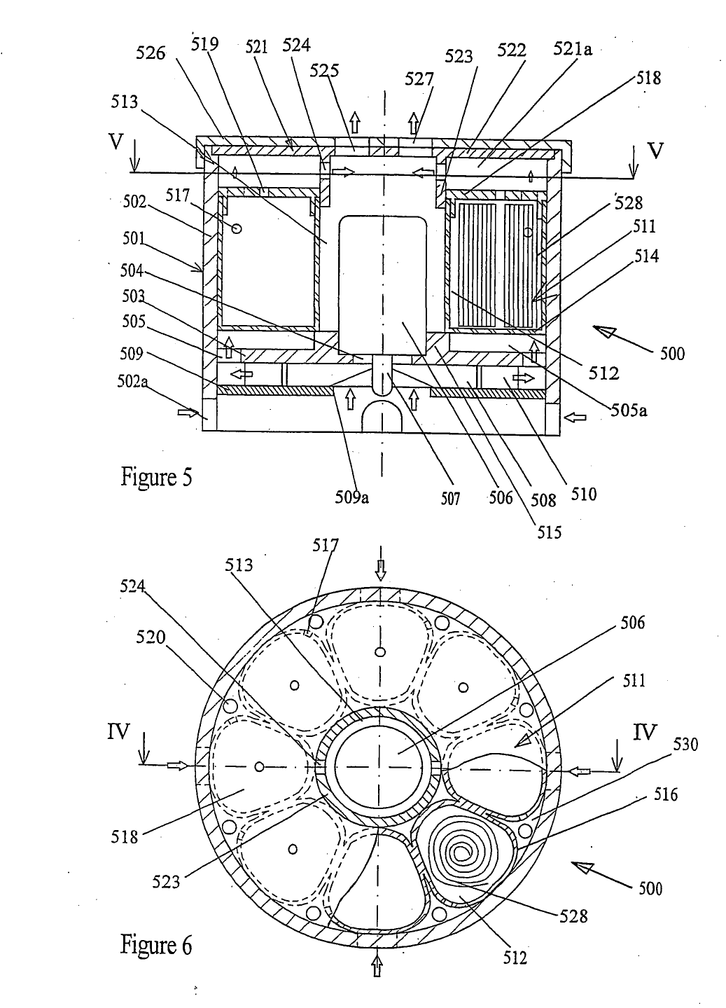

FIG. 5 shows, in median vertical section, an embodiment of an evaporator according to the invention.

FIG. 6 shows a horizontal section along VI-VI of the evaporator of FIG. 5.

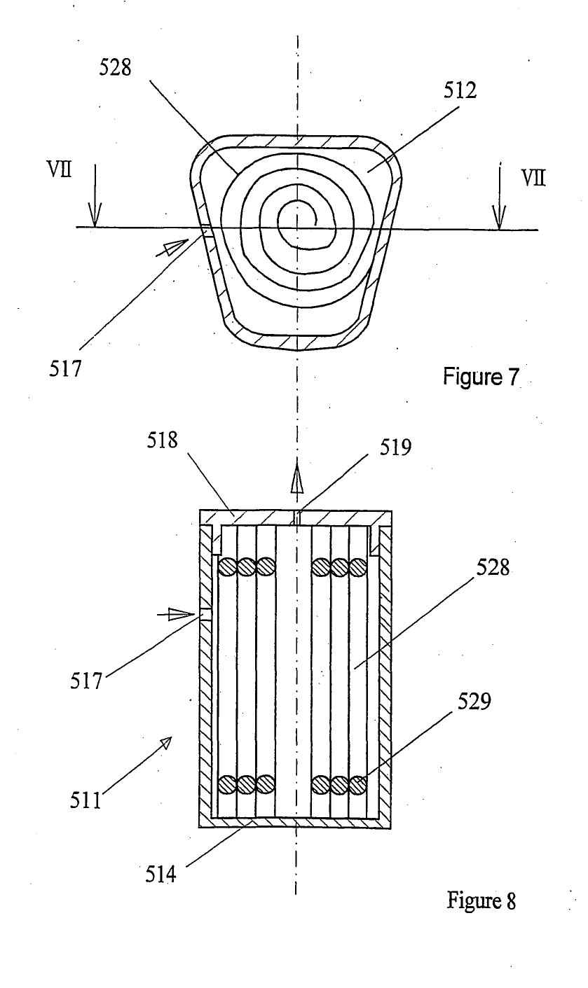

FIG. 7 shows a horizontal section of a container of the evaporator of FIG. 5.

FIG. 8 shows a vertical section of the container of FIG. 7.

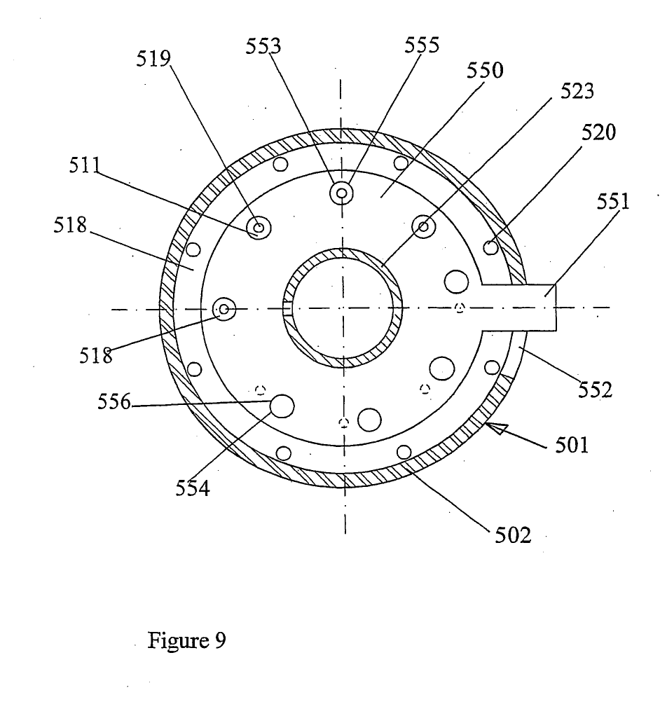

and FIG. 9 shows a section corresponding to that of FIG. 6 of an alternative embodiment of the evaporator of FIGS. 5 to 8.

FIG. 1 shows a set of n containers 101 in each of which a wad of cellulose 102 has been placed, impregnated with a pure constitutive substance of a perfume.

These containers are provided with two ducts 103 and 104 disposed at their opposite ends. The first of these ducts 103 is connected to a second air distributor 105, itself connected to a first air distributor 115 supplied by a fan 106 common to the set of distributors 105 and containers. It is provided with a stop valve 107 which is either open or closed. The second duct 104 is provided with an airflow rate-regulating valve 108 for the air passing through the container. It is known how to adjust this valve as a function of the pressures existing on each side of the container to set a flow rate or, conversely, knowing the adjustment and the pressures, to deduce the flow rate. The device is equipped with pressure measuring means (not shown) belonging to the known art and permitting these conditions to be attained. This circuit is hereinafter termed the first circuit.

In FIG. 1, the containers have been distributed in four categories as a function of the vapor pressure of the substances to be diffused. The set of containers of one category is connected to one of the distributors 105. An airflow rate-regulating valve 109 has bee placed between the fan and each of these sets, and permits a greater flow rate in the containers containing the less volatile products and on the contrary a flow which is relatively smaller as the volatility of the substances increases.

The airflows leaving the containers then pass into collectors 128, then into a mixer 129 common to the set of containers.

A common regulating valve 110 is placed at the outlet of the set of containers and permits the total airflow passing through the set of containers to be adjusted. By opening the valve 110 more or less, the global airflow passing into the containers is modified, while maintaining the proportion to the total flow rate of the flow rate passing into one or other of the containers.

The flow of air passing into each container may be heated by means of electrical resistances 111. In practice only the low volatility products will need such heating, which explains why only one resistance has been shown in FIG. 1.

The total flow of air passing into the containers is purified by means of cartridges of active carbon 112 situated in the flow common to the set of containers, upstream of these, at the outlet of the fan. This device may be completed by a cartridge 113 intended to lower the water vapor content of the air passing through the device and also by an air conditioner 114 permitting its temperature to be set.

One of the containers used 119 contains water, which is a particular constituent of a perfumed mixture. It permits control of the humidity of the air leaving the device. Generally this particular container, through which passes an airflow much greater than that of the other containers, is supplied by a specific fan 120 whose flow rate is much greater than that of the fan which creates the airflow passing through the containers. In order to control the airflow rate, two parallel circuits 127 and 132 are used, provided with flow rate control valves 124, 125 and 126. This circuit is termed the second circuit.

The moist air leaving this second circuit is then mixed with the air, laden with perfume, which has passed through the first circuit, this mixing being effected in the mixer or chamber 130. After mixing, the flow of perfumed air leaves the device by the orifice 131.

Operation is then as follows.

The airflow rate passing into each container 101 is sufficiently low that the air is saturated with the vapor of the constituent of the container, that is, that the partial vapor pressure of the said constituent in the air is about equal to what it would be after a very long time in stagnant air. This partial pressure is termed the vapor pressure at the temperature considered. In practice, the ratio between this partial pressure of the pure constituent in air and its vapor pressure will be at least equal to 0.8. Such a condition is obtained according to the invention by using porous bodies whose exchange surface is sufficiently large, which are wads of cellulose in our example, these methods being known in the prior art.

It can be seen that it is possible, by adjusting the airflow rate-regulating valves common to a category of containers and, for each container of a category, the regulation of the valve belonging to it, to meter the quantities of vapor of the different pure substances entrained from each container.

The airflows thus leaving the containers and containing known quantities of perfumes are then mixed together in a first mixer 129, then with the airflow of the secondary circuit in a second mixer 130.

The disposition of the general regulating valve 110 situated between the first mixer and the second mixer permits the relative proportions of perfume to be retained while modifying the total airflow rate of the first circuit, saturated with perfume, leaving the set of containers. The strength of the perfume in the outlet airflow may thus be adjusted by operating on the opening of the valve 110.

The thus constituted assembly therefore permits implementation of a metering and mixing system for pure substances constituting a perfume, this mixture, whose proportions and total flow rate are continually adjustable, itself being mixed with a variable airflow. It thus permits an atmosphere containing a perfume whose constituents are controlled in proportions and in quantity to be created. In principle, as long as the number of base substances is sufficient, any odor whatever may be created at will, the odor being the result, agreeable or not, of a mixture of such elementary substances. This system is particularly well suited to creation in perfumery.

In general, the apparatus will be controlled by an automatic controller permitting the operations of metering and mixing to be performed as well as the measurements necessary for their control. This automatic controller will be provided with composition memory means as well as automatic modes permitting particular mixtures to be created. In general, the concern is to create in the air a homogeneous mixture of elementary substances in defined proportions. This automatic controller, belonging to the known art, is not shown in FIG. 1.

FIGS. 2a and 2b give another embodiment example of the invention in which a limited number of containers 201 (201a-201h) is used, for example, eight containers. Each of these containers is filled with a porous body 202 imbibed with a mixture of several elementary substances of similar volatility. In this example, this porous body 202 is a wad of cellulose.

“Volatility of a pure substance” hereinafter means the product of the vapor pressure of the said substance by its molar weight.

The first container 201a is filled with the most volatile elementary substances, characterized by a maximum ratio of their volatilities equal to 2. The second container 201b is filled with substances which are a little less volatile, likewise with a maximum ratio of volatilities equal to 2. The following containers are filled according to the same principle with substances of lower and lower volatilities.

It can be seen that by using eight containers, the range of volatilities covered is at least equal to 28 (two to the power 8), i.e. 256. This means that the ratio of the volatility of the most volatile substance contained in the first container to the volatility of the least volatile substance contained in an eighth container is at least 256. In general, the range covered will be slightly greater than 256, since the volatilities of the substances constituting a material are discrete values and the passage from one container to another is never made continuously.

The relative quantity of each constituent in the set of containers is generally equal to the proportions of the said substances which it is desired to obtain in the air.

As above, the containers are provided with an inlet orifice 203 communicating with an inlet chamber 203a and with an outlet orifice 204 communicating with a mixing chamber 208, the surface area of the inlet orifice 203 being much greater than that of the outlet orifice 204. A fan 205 driven by a motor 206 permits introduction of air into the inlet chamber 203a.

A flow rate of air into each of the containers is set by means of the fan 205, by setting or calibrating for each of them the surface area of the outlet orifice 204 so that the desired flow rate is obtained. This type of control is performed by application of the laws of fluid mechanics which belong to the known art. These individual flows of air passing through the containers then pass into a mixing chamber 208 which permits a homogeneous mixture of air and of the different perfume constituents to be obtained, these perfume constituents being in the finally desired proportions in the air.

In the embodiment example, these individual flow rates are mixed with a non-perfumed airflow passing around the containers and in particular into the orifices 209 and 207 in order to avoid deposits by condensation.

At the end of the mixing chamber 208 there is disposed a controllable outlet orifice 210 acting as a valve intended to control the total flow rate passing through the device, this outlet orifice 210 being controllable by rotation of two disks 210a and 210b having corresponding through orifices brought more or less into coincidence. There are thus means for controlling, on the one hand the relative proportions of the different substances by setting the output cross sections of the containers by means of the orifices 204, and on the other hand the total quantity of substances evaporated by adjusting the adjustable output orifices 210.

In the case shown in FIGS. 2a and 2b, the dimensions of the device are small. The fan is supplied by electric batteries 211.

The dimensions of the apparatus, by way of example, are the following.

Each container is provided with hydrophilic wads impregnated with the perfume constituents to be evaporated. They all have a diameter of 25 mm and a height of 40 mm. The cross section of the inlet orifice of the containers is 0.75 cm². The vapor pressure of the most volatile substance placed in the container 201a is 10 Pa and its molar weight is 150 g. The volatility of this substance is thus equal to 1.5 Pa·kg. The vapor pressure of the least volatile substance placed in the last container 201h is 0.02 Pa and its molar weight is 200 g. The volatility of the substance is thus equal to 0.004 Pa·kg.

The first container initially contains a total weight of perfume constituents of 2 g and the last a total weight of 0.5 g. The airflow rates used are respectively 1.5 ml/s for the first container and 90 ml/s for the last container. For the other containers, they depend on the exact composition of the mixtures which they contain. The device permits perfume to be diffused into a room of about 25 m³. The total weight of perfume after filling the device is 10 g, corresponding to an operating period of a month.

The total flow rate of the fan is 500 ml/s, of which only 200 ml/s pass into the container. The residual airflow rate of 300 ml/s passes into the specific ducts situated between the containers before it is mixed with the airflows, about saturated with vapor, leaving each of the said containers. The theoretical (aerodynamic) power of the fan is 5 mW, which, taking account of the efficiency, leads to a real power of 20 mW. The fan is connected to an electrical network, which permits the air entering the last container 201h by means of the electrical resistance (not shown) to be heated. In another version of the invention, the motor can be supplied by electric accumulators 211 or by individual automobile cigarette lighter outlets.

In the case shown in FIG. 3, the device is used to perfume a large space, such as, for example, a public transportation station. The volume of this station is, for example, fifteen thousand cubic meters. To obtain the same perfume intensity as in the previous case, a flow rate of perfume proportional to the volume has to be evaporated. In this particular case, this flow rate was ten grams per month for twenty-five cubic meters. It thus becomes equal to six thousand grams per month, i.e., six kg/month for a public transportation station. In order to disperse the perfume sources, ten devices of this type are used, the total initial charge of perfume being six hundred grams, thus sixty times greater than the previous case.

The principal constituents of this evaporator remain the same as in the previous case shown in FIG. 2.

In the example of FIG. 3, the containers 301 are disposed one above another in a cylindrical column 306. The air which enters the column through lower inlet orifices 310 via an inlet chamber 302a is driven by a lower fan 305. It then passes through containers 301 which are provided with lateral internal inlet orifices 302 and lateral external outlet orifices 303. On passing into the containers 301, the air becomes laden with the perfume mixtures which impregnate the wads 304 contained in the containers. It then passes into the annular space 307 surrounding the containers 301 and into an upper mixer or upper mixing chamber 308.

A portion of the air does not pass through the containers but is directly introduced into the mixing chamber 308 through orifices 311 and the annular space 307. The mixture of this pure air and the laden air is effected in the mixer 308; the total airflow rate is regulated by opening more or less the variable cross section orifices 309 formed by placing more or less in coincidence, orifices arranged in the upper portion of the column 306 and in an added cover 308a. All the functions of the diffuser shown in FIG. 2 are thus reproduced.

FIG. 4 shows a perfume display unit 409 equipped with several sets of containers 403, each of the said sets of containers containing a specific perfume. Each set of containers is connected to a fan 401 common to the display unit and supplied with pure air through orifices 409. Each set of containers is furthermore provided with a valve 404 permitting the air coming from the fan to pass through it or not according to whether it is open or closed.

In the example of FIG. 4, the open valve is denoted by 405. This air laden with perfume is then introduced into the tubing 406, then into the mixer or chamber 407. A principal flow of air coming from the fan passes directly to the mixer through the duct 410, permitting the production of an intimate mixture of the principal flow of air and the flow of perfumed air which has passed through at least one set of containers.

There is thereby created at the outlet 408 of the display unit a mixture of air and perfume whose odor is exactly similar to that which will be produced in a domestic room using a diffuser with multiple containers containing the same mixture of perfumes as the container in operation. The consumer may thus choose a perfume corresponding to his tastes. The opening of the valves can of course be automated and it is possible to test a mixture of several perfumes, or of essences such as, for example, those used in aromatherapy. To do this, it is sufficient to simultaneously open several valves 404.

The evaporator 500 shown in FIGS. 5 to 8 comprises a casing 501 which comprises a vertical cylindrical wall 502 and a radial horizontal wall 503 at a small distance from its lower end.

This radial wall has a central passage 504 and passages or orifices 505 distributed on its periphery. The radial wall 503 supports above it a motor 506 whose axis 507 passes through the passage 504 and is provided, beneath this radial wall, with a fan blade wheel 508. An added radial wall 509 is fixed to the container 501 and extends just below the blades 508, this added wall having an inlet passage 509a. Below this added plate 509, the peripheral wall 502 of the container 501 has inlet orifices 502a. Rectifying blading 510 supported by the added plate 509 and surrounding the blades 508 is provided between the radial wall 503 and the added radial wall 509.

The evaporator 500 furthermore comprises a cartridge 511 of generally cylindrical form which delimits eight vertical containers 512 distributed around a central passage 513 into which the motor 506 is inserted. This removable cartridge is fitted from above into the casing 501, its lower radial wall 514 being kept spaced from the radial wall 503 by means of a projecting support 515 provided on this radial wall around the motor 506, such that an inlet chamber 505a is formed beneath the removable cartridge 511.

The peripheral portion of the cartridge 511 has vertical grooves 516 formed between each container 512 and in the lower radial wall 514. Each container 512 has at least one lateral through inlet orifice 517 connected to an adjacent groove 516. This lateral through orifice 516 is placed at about the mid-height of each casing.

The radial upper wall 518 of the cartridge 511, the periphery of which is adjusted in the casing 501, has calibrated through outlet passages or orifices 519 which are placed at the center of the containers 512. The upper wall 518 furthermore has calibrated through passages or orifices 520 respectively situated above the grooves.

The evaporator 500 furthermore has a removable intermediate cover 521 placed above the removable cartridge 511. This intermediate cover 521 comprises a radial disk 522, the periphery of which rests on an internal shoulder of the upper edge of the peripheral wall 502 of the container 501 and which extends above and spaced from the cartridge 511. The intermediate cover 521 furthermore comprises a cylindrical skirt 523 projecting downward from the disk 522 and lightly fitting into the central passage 513 of the removable cartridge, this skirt having passages 524 opening above the cartridges.

The removable intermediate cover 521 thus delimits a mixing chamber 521a above the cartridge 511, including the central passage 513 obstructed at its lower portion by the radial wall 503 and the motor 506.

The disk 522 furthermore has, for example, two off-center through orifices 525 opening into the interior of the skirt 523.

The evaporator 500 likewise comprises a removable upper cover 526 which envelops the upper portion of the casing 501 and which has two orifices 527 which may be brought into coincidence with the orifices 525 of the intermediate cover 521.

As shown more precisely in FIGS. 7 and 8, permeable materials constituted by ribbons 528 rolled into spirals are disposed in the containers 512. The turns of the ribbons 528 are kept spaced apart, for example by coiled wires 529. The ribbons extend over the whole height of the containers 512 and are impregnated with volatile substances.

The evaporator 500 is particularly intended to reconstitute a perfume from the evaporation of its elementary constituents. To perform this operation, the ribbons 528 contained in each of the containers 512 are impregnated with the elementary perfume constituents whose products of molar weight by their vapor pressure, representing the volatility, are sufficiently close. Thus each of the containers contains more and more volatile mixtures of constituents.

For example, if it is considered that the maximum separation of the volatilities of the kinds contained in a casing is 2, it can be seen that by using 8 containers, at least a range of volatilities equal to 2⁸, i.e. 256, is covered. The permeable materials being impregnated with perfume constituents, the air passing at low speed into each container becomes laden with the constituents which it contains.

It can thus be seen that it is sufficient to regulate a suitable airflow rate in each of the casings to cause their contents to evaporate at a flow rate of weight proportional to the airflow rate. By operating on the relative quantities of products contained in each container and on the ratios of the airflow rates between the containers, any composition of perfume can thus be reconstituted whose elementary constituents are those contained in the casings.

With the airflow rates leaving each casing being themselves proportional to the corresponding calibrated orifice surface 519 and to the square root of the pressure difference obtaining between the interior of the groove 516 and of the mixing chamber 521a, the relative flow rates of each of the constituents are independent of the total airflow rate. When the constituents contained in the casings are those of a perfume, it is observed that the quality of the latter, its odor, is constant as a function of time, since it only depends on the relative quantities of the elementary constituents of the perfume.

Like the evaporators described with reference to the previous figures, the evaporator 500 operates in the following manner.

When the blades of the fan 508 are driven by the motor 506, the air entering by the lower portion of the container 501 through lateral passages 502a is directed between the radial walls 503 and 509 to pass via the passages 505 into the inlet chamber 505a. The air then enters the vertical channels 530 formed by the vertical grooves 516 of the cartridge 511 and the cylindrical wall 502 of the container 501. A portion of the air enters the containers 512 through the lateral orifices 517, while the other portion passes through calibrated through orifices 519. The portion of the air entering the containers 512 is forced to pass between the turns of the ribbon 528 of permeable material and leaves the containers again by calibrated upper orifices 519 while being laden with the vapors of the constituents with which the ribbons 528 are impregnated.

The laden air coming from the containers 511 and the non-laden air coming from the orifices 519 are mixed during their passage into the upper chamber 521a, and the mixture is evacuated toward the exterior through orifices 525 of the intermediate cover and 527 of the upper cover.

The calibrated upper orifices of the cartridge 511 are respectively adjusted for the volatile substances contained in each, and the direct air circulation orifices are calibrated as a function of the orifices 511 and of the maximum desired flow rate of the volatile materials.

By causing the upper cover 526 to turn, it is possible to regulate the outlet cross section of the evaporator by causing the orifices 525 of the intermediate cover 521 and the orifices 527 of this upper cover 526 to coincide more or less.

When the constituents to be evaporated contained in the removable cartridge 511 are used up, it is sufficient to remove the upper cover 526 and then the intermediate cover 521, to extract the cartridge 511, to install a new cartridge 511 with impregnated ribbons 528, and to replace the upper cover 526 and then the intermediate cover 521.

Referring to FIG. 9, it can be seen that an alternative embodiment is shown of the evaporator 500 described with reference to FIGS. 5 to 8, in which this evaporator is provided with an annular disk 550 which is placed flat on the upper face of the wall 518 of the cartridge 511. This disk 550 has a central passage fitted with little play around the skirt 523 of the intermediate cover 521 and has an external diameter situated at a distance from the cylindrical wall 502 of the casing 501 so that the orifices 520 of the wall 518 of the cartridge 511 are not covered.

The disk 550 has a tongue 551 which extends flat from its periphery and which passes through a slot 552 formed in the cylindrical wall 502 of the casing 501 such that by acting on the tongue 551, the disk 550 can be caused to turn around the skirt 523 between two extreme positions in which the tongue comes to stop against the respective ends of the slot 552.

The disk 550 has two series 553 and 554 of through passages 555 and 556 disposed such that, when it is placed at one of its extreme positions, the through passages 555 uncover certain of the orifices 519 of the cartridge 511 and, when it is placed at its other extreme position, the through passages 556 uncover the other orifices 519 of this cartridge.

The evaporator 500 is thus suited for generating two volatile substances. For this, elementary constituents to be evaporated are disposed in the containers capable of being opened by the series 553 of through passages 555 of the disk 550, different than those disposed in the containers capable of being opened by the series 554 of through passages 556.

The present invention is not limited to the examples described hereinabove. Many other alternative embodiments are possible without departing from the scope defined by the accompanying claims.

1. Method of constituting by evaporation, a volatile substance comprising at least a predetermined number of elementary constituents, characterized in that it consists: in causing flows of a gas, controlled or regulated in flow rate, to flow in parallel through containers (101, 201, 301, 511) each containing at least one elementary constituent to be evaporated, impregnated into a permeable material (102, 304, 528), and in mixing the flows of gas laden with evaporated constituents leaving the said containers, so as to obtain an outlet flow of gas containing predetermined or controlled concentrations of the said evaporated constituents.

2. Method according to claim 1, characterized in that it consists in controlling or regulating the flow rate of gas in each container by causing this gas to pass through at least one calibrated or adjustable orifice (108, 204, 303, 519, 550).

3. Method according to either of claims 1 and 2, characterized in that it consists in causing the outlet flow to pass through at least one calibrated or adjustable orifice (110, 210, 309, 404, 525).

4. Method according to any one of the foregoing claims, characterized in that it consists in placing in at least certain of the said containers, elementary constituents having different volatilities, impregnated into permeable materials (102, 304, 528).

5. Method according to any one of the foregoing claims, characterized in that it consists in independently regulating the gas flows flowing in each of the containers.

6. Method according to any one of the foregoing claims, characterized in that it consists in generating a flow of gas, a portion of which passes through the containers (201, 511) and is directed toward a mixing chamber (208, 521a) and another portion of which is directed directly toward this mixing chamber, the latter having an outlet.

7. Device for constituting by evaporation a volatile substance comprising at least a predetermined number of elementary constituents, characterized in that it comprises: means (106, 120, 205, 305, 401, 508) for causing flows of a gas, controlled or regulated in flow rate, to flow in parallel through containers (101, 201, 301, 511) each containing at least one elementary constituent to be evaporated impregnated into a permeable substance (102, 304, 528), and means (130, 208, 308, 407, 521a) for mixing the gas flows laden with evaporated constituents coming from the said containers, so as to deliver to the outlet of the said mixing means a gas flow containing predetermined or controlled concentrations of the said evaporated constituents.

8. Device according to claim 7, characterized in that it comprises means (104, 108, 204, 303, 519, 550) for calibrating and/or controlling the flow rates of gas passing through the said containers.

9. Device according to one of claims 7 and 8, characterized in that it comprises means (110, 210, 309, 404, 525, 527) for calibrating and/or controlling the flow rate leaving the said mixing means.

10. Device according to any one of claims 7 to 9, characterized in that the said mixing means comprise at least one chamber (130, 208, 308, 407, 521a) connected to the outlets of the said containers and having at least one outlet.

11. Device according to one of claims 8 and 10, characterized in that the said calibrating and/or control means comprise at least one calibrated and/or adjustable orifice.

12. Device according to any one of claims 7 to 11, characterized in that the said circulation means comprise at least one fan (106, 205, 305, 401, 508).

13. Device according to any one of claims 7 to 12, characterized in that the said containers have calibrated or adjustable orifices (110, 517, 519) for inlet and/or outlet of gas passing through them.

14. Device according to any one of claims 7 to 13, characterized in that at least certain of the containers are equipped with heating means (111).

15. Device according to any one of claims 7 to 14, characterized in that it comprises means (114) for heating the gas flows passing through at least certain of the containers before it comes into contact with the constituents to be evaporated.

16. Device according to any one of claims 7 to 15, characterized in that the said circulation means comprise a fan (205, 508) generating a gas flow, a portion of which passes through the containers (201, 511) and is directed toward a mixing chamber (208, 521a) and another portion of which (520) is directed directly toward this mixing chamber, the latter having an outlet.

17. Device according to any one of claims 7 to 16, characterized in that it comprises a casing (501) adapted to receive a removable cartridge (511) delimiting the containers (512) having gas inlet orifices (517) and gas outlet orifices (519), a mixing chamber (521a) into which the outlet orifices (519) of the containers open and having at least one outlet orifice (525, 527) toward the exterior, gas supply ducts (530) connecting a gas inlet chamber (505a) to the inlet orifices of the containers and to the mixing chamber, and a fan (508) for supplying gas to the inlet chamber.

18. Device according to claim 17, characterized in that it comprises a cover (521, 526) mounted on the said casing and having the said outlet orifice toward the exterior of the said mixing chamber.

19. Device according to claim 18, characterized in that the said cover has two portions (521, 526) comprising orifices (525, 527) and turning one with respect to the other so as to regulate the correspondence between these orifices.

20. Device according to any one of claims 7 to 19, characterized in that the said elementary constituents are impregnated into permeable materials constituted by ribbons (528) rolled in spirals, the turns of which are spaced apart and disposed so that the gas flows passing through the containers pass between these turns.
